(19) United States
(12) Patent Application Publication
(10) Pub. No.: US 2010/0229098 A1
(43) Pub. Date: Sep. 9, 2010

(54) CONFIGURATION OF INTELLIGENT ELECTRONIC DEVICE

(75) Inventor: Thomas KUENG, Nussbaumen (CH)

Correspondence Address: BUCHANAN, INGERSOLL & ROONEY PC, POST OFFICE BOX 1404, ALEXANDRIA, VA, 22313-1404, US

(73) Assignee: AB Technology AG, Zurich (CH)

(21) Appl. No.: 12/717,685

(22) Filed: Mar. 4, 2010

Related U.S. Application Data
(63) Continuation of application No. PCT/FI2007/050477, filed on Sep. 7, 2007.

(51) Int. Cl. G06F 3/048; G06F 15/16

(52) U.S. Cl. 715/736

(57) ABSTRACT

An arrangement is disclosed for configuring an intelligent electronic device, having a configuration unit configured to provide a plurality of function blocks into a visual representation of a configuration of the intelligent electronic device. Each function block is configured for executing a function in the intelligent electronic device and has a predetermined set of connection interfaces for connecting the function block with other function blocks or external variables. A checking unit is configured to check, for a function block, a completion status of the connections of the function block in the configuration, and an indicating unit is configured to provide a visual indication in the visual representation to indicate the completion status of the connections of the function block.

### RELATED APPLICATIONS

This application claims priority as a continuation application under 35 U.S.C. §120 to PCT/FI2007/050477 filed as an International Application on Sep. 7, 2007 designating the U.S., the entire content of which is hereby incorporated by reference in its entirety.

### FIELD

The disclosure relates to configuration of an intelligent electronic device.

### BACKGROUND INFORMATION

In a configuring process of intelligent electronic devices, a graphical tool may be used. When using the tool, a user may collect function blocks and connect them such that the inputs and outputs of each function block are connected either to other function blocks or to external input/output variables. After completion of the configuration, the configuration may be compiled, which compilation provides a compilation result. The compilation result may be a listed printout of possible errors in the configuration. The user then corrects the errors in the configuration one-by-one, reading the listed printout and correcting errors to the graphical representation. After the correction of the compilation errors, the user may try compilation of the configuration again, and repeat the above-described procedure until the compilation process indicates no more errors. This process can be tedious and time-consuming.

### SUMMARY

A apparatus is disclosed, comprising: a configuration unit configured to provide a visual representation of a configuration of an intelligent electronic device with plural function blocks, wherein each function block is configured for executing a function in the intelligent electronic device and has a predetermined set of connection interfaces for connecting the function block with at least one of another function block and an external variable; a checking unit configured to check a completion status of connections of at least one function block in the configuration; and an indicating unit configured to provide the visual representation with a visual indication to indicate the completion status of the connections of the at least one function block.

A method is also disclosed, comprising: visually representing a configuration of an intelligent electronic device with a plural function blocks, wherein each function block is configured for executing a function in the intelligent electronic device and has a predetermined set of connection interfaces for connecting the function block with at least one of another function block and an external variable; checking a completion status of the connections of at least one function block in the configuration; and visually indicating, in the visual representation, the completion status of the connections of the at least one function block.

A computer program product is disclosed which is stored on a computer readable medium, encoded with a computer program of instructions which, when executed by a computer causes the computer to perform the following: providing a visual representation of a configuration of an intelligent electronic device with plural function blocks, wherein each function block is configured for executing a function in the intelligent electronic device and has a predetermined set of connection interfaces for connecting the function block with at least one of another function block and an external variable; checking a completion status of the connections of a function block provided in the configuration; and indicating, by using a visual indication in the visual representation, the completion status of the connections of the function block.

### BRIEF DESCRIPTION OF THE DRAWINGS

In the following, the disclosure will be described in greater detail with reference to exemplary embodiments and the accompanying drawings, in which:

FIG. 1 shows an exemplary method disclosed herein;

FIG. 2 shows an exemplary embodiment of an apparatus disclosed herein;

FIG. 3 shows another exemplary embodiment of an apparatus disclosed herein; and

FIG. 4 illustrates an exemplary visual interface of a configuration on a display.

### DETAILED DESCRIPTION

An exemplary configuration arrangement is disclosed for configuring an intelligent electronic device, having a configuration unit configured to provide a visual representation of a configuration of the intelligent electronic device with a plurality of function blocks. Each function block can execute a function in the intelligent electronic device, and has a predetermined set of connection interfaces for connecting the function block with other function blocks or external variables. A checking unit can be configured to check a completion status of the connections of a function block in the configuration. An indicating unit can be configured to provide the visual representation with a visual indication to indicate the completion status of the connections of the function block.

An exemplary method is also disclosed for configuring an intelligent electronic device. A plurality of function blocks are provided in a visual representation of a configuration of the intelligent electronic device, wherein each function block can execute a function in the intelligent electronic device and has a predetermined set of connection interfaces for connecting the function block with other function blocks or external variables. The method includes checking, for a function block, a completion status of the connections of the function block made into the configuration, and indicating by using a visual indication in the visual representation the completion status of the connections of the function block.

An exemplary user interface as disclosed herein can configure an intelligent electronic device, and provide a possibility to avoid at least some of the unnecessary compilations of the configurations.

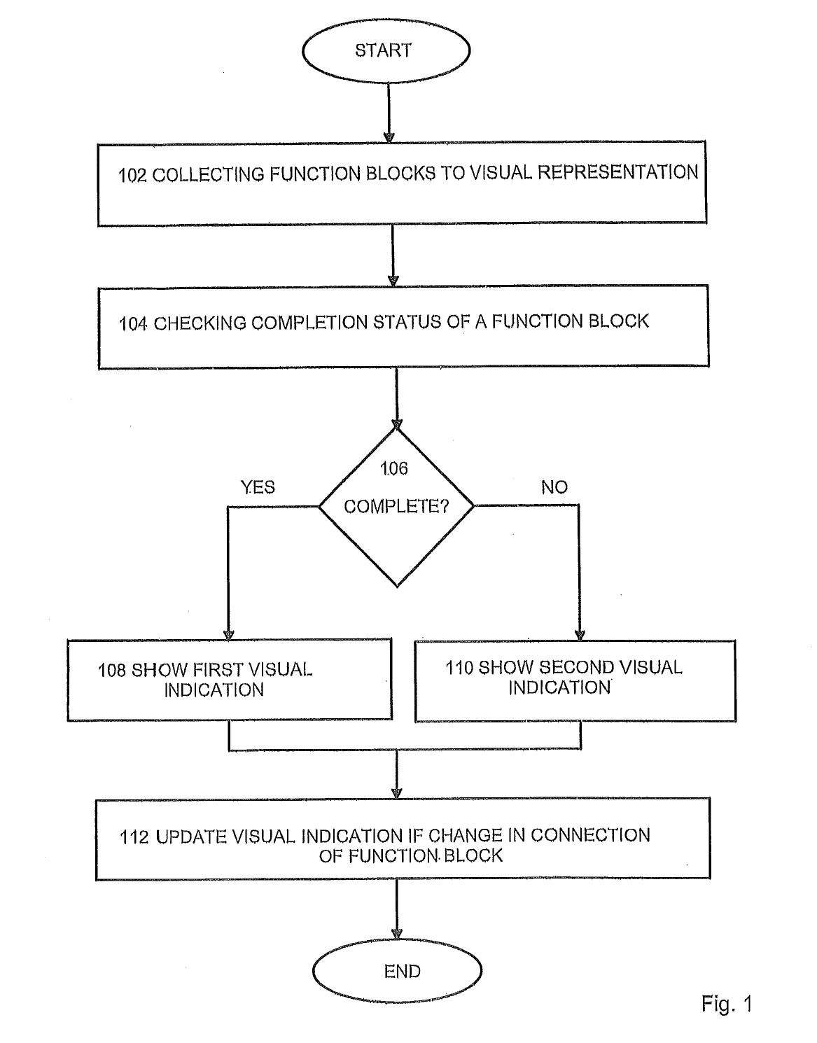

FIG. 1 shows an exemplary method as disclosed herein. The method relates to configuring of an intelligent electronic device, such as a protective relay, for instance. The protective relay may be for use in a power transmission and distribution system. In configuring, the operation of the device can be defined by using one or more function blocks, each defining a function that may be carried out during the operation of the device. The configuration may be carried out using a graphical/visual configuration tool, in which function blocks that are included in the device are collected to a visual display of the tool as shown by block 102 in FIG. 1.

Each function block may include one or more inputs and one or more outputs. Via these connection interfaces, a function block may be connected to other function blocks or to external variables. Some of the connection interfaces may be obligatory connections, whereas some other connection interfaces may be optional connections. An obligatory interface refers to a particular interface that, for desired operation, needs to be connected either to another function block or to a variable.

In an exemplary checking block 104, the configuration tool performs a check relating to the obligatory interfaces, and the optional interfaces are not checked. In an exemplary embodiment, the user interface provides either a menu choice or a push button for initiating the checking of the status of the connections in the configuration. When the user makes the menu selection or presses the push button, the tool may check all the interfaces in all the function blocks in the active configuration that the user is working on.

As shown by block 106, the checking of the interfaces can provide a completion status of the function block. When all the obligatory interfaces of a function block have been connected, the completion status of the function block is “complete”. The method can then branch to block 108 and the configuration tool provides a first visual indication on a display of the configuration tool. The first visual indication may, for example, be a color, a certain line thickness of the function block, or a single frame around the block.

If the completion status of the function block is “incomplete”, the method branches to block 110, and a second visual indication is displayed. The second visual indication provides a visual difference to the first visual indication. If the first visual indication is a color, the second visual indication may, for example, be another color. For instance, a green color may indicate the “complete” status, and a red color may indicate the “incomplete” connection status of the function block. If the first visual indication is a line thickness, the second visual indication may be another line thickness of the function block. If the first visual indication is a single frame around the function block, the second visual indication may be a double frame around the block. The two latter indications may also be used by those who suffer from color vision deficiency.

The visual indication of the connection statuses may also be carried out by using two different indication manners, such as color and line thickness. For instance, the first visual indication may be a color and the second indication may be a line thickness.

As explained above, the visual indication may be applied for the whole block. That is, a certain color may be applied to the frame or the interior of a function block. In another exemplary embodiment, a visual indication is provided only at the interface of the function block, not around or inside the function block. A small frame may be provided at an input/output of a block, and the visual indication may be provided at this small frame. These two embodiments may also be used in common, that is visual indications may be applied both to the inputs/outputs of the blocks and also to the frames/interiors of the blocks.

The configuration tool may also provide an additional listing window on the display. The listing window may, for example, indicate the incomplete connections in the configuration in a textual format. Thus, in addition to the visual indication, the listing window may help the user in noticing which connections still need to be connected. The listing window may be updated when carrying out the check in block 104, for instance. When the listing window is empty, this also indicates that the configuration is complete in a sense that all desired, and/or needed connections have been connected.

In block 112, a new connection is established between, for example, two function blocks. An exemplary method may then automatically perform the check in block 104, and update the visual indication of the block. For instance, if a newly added connection completes the connections of a function block, the connection status of the block may change from “incomplete” to “complete”. Thus, block 112 may be seen as an alternative for block 104. The configuration tool may check the connections either upon a request from the user or automatically.

Alternatively to two values of the connection status, the connection status of the function block may belong to one of three values, “complete”, “partly complete” or “incomplete”. “Partly complete” may denote that at least one of the desired and/or necessary interfaces of a function block has been connected. If a color is used as a visual indication method, green, yellow and red may be used, for instance.

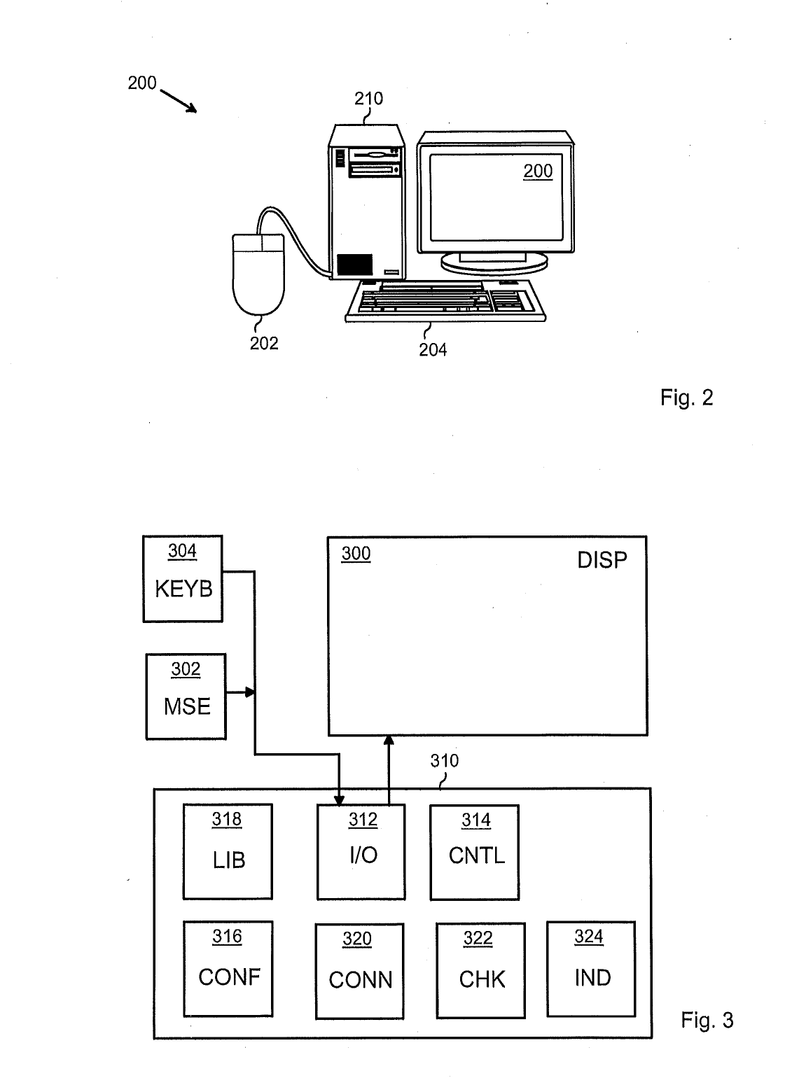

FIG. 2 shows an exemplary embodiment of an apparatus that may be used in the configuration work. The apparatus may be a workstation 200 including a mouse 202 and a keyboard 204. The user making the configuration may use the mouse and the keyboard for adding/deleting function blocks to/from a configuration. The user may establish connections between the blocks by drawing connecting lines between the function blocks and/or to/from external variables.

The display 200 shows visually the function blocks and the connections relating to the function blocks. By means of the display, the user may see the connection status of the function blocks. On the display, various exemplary differentiation methods may be used. The status information may be seen on the basis of colour, line thickness, or frame format. Different hatching or fillings of the function blocks may also be used. Manners of differentiation other than color indication are also suitable for use by those who suffer from color vision deficiency.

A central unit 210 of the workstation 200 may include a software package, which is suitable for use in the configuration of the intelligent electronic device. The software package may co-operate with the mouse 202 and the keyboard 204 in receiving inputs from the user. The software may also instruct the display 200 in displaying the connection statuses of the function blocks.

In an exemplary embodiment, a visual indication is also provided with regard to the entire intelligent electronic device. When all the connections of all the function blocks have been completed, the connection status of the intelligent electronic device can be set to “complete”. Otherwise, if not all the connections have been connected, the connection status of the function block may be set to “partly complete” or “incomplete”, depending on how many different groups are available for indicating the connection statuses.

FIG. 3 shows another exemplary embodiment of an apparatus for performing the configuration. As in FIG. 2, by using a mouse 302 and a keyboard 304, a user is able to feed input information to provide the configuration for the intelligent electronic device. Instead of, or in addition to, a mouse/keyboard, other known input methods such as touching, and/or speech may be applied as well.

A central unit 310 may include an input/output unit 312, which may handle the external interfaces of the central unit. Via the input/output unit, the central unit may receive input data from the keyboard 304 and the mouse 302, and may output data to a display 300.

FIG. 3 also shows a central unit 310, which includes a plurality of subunits. For the sake of simplicity, no connections between the subunits are shown in FIG. 3.

The central unit 310 may include a configuration unit 316, which may be responsible for opening a new configuration and adding/deleting function blocks to/from the configuration. The configuration unit may co-operate with the display 300 so that the configuration is visually shown on the display during the configuration process. A library 318 including a selection of function blocks available to be selected by the configuration unit 316 may also be provided. The configuration unit may also be responsible for providing a listing of all devices in a larger configuration and illustrating the relations between the devices and a hierarchy of the devices.

A connection unit 320 may also be provided. The connection unit may be responsible for providing functions needed in making the connections for a function block. The function blocks may be connected with each other, or they may receive an input variable, or they may output an output variable.

A checking unit 322 may also be provided. The checking unit cooperates with the connecting unit in such a way that when a connection is added to or removed from a function block, the checking unit may check whether the connection status of a function block has changed. A function block may have one or more predetermined obligatory inputs and one or more obligatory outputs. If all the obligatory inputs and outputs have been connected, the checking unit may provide a connection status value “completed” for the function block. If at least one of the obligatory inputs/outputs has been connected but not all of them, a connection status value “incomplete” or “partly completed” may be provided. For internal processing, respective numerical values 0, 1 or 2 may be associated with each connection status value, for instance.

An indicating unit 324 may co-operate with the checking unit such that when the checking module provides a function block with a connection status value, the indicating unit changes the visual representation of the function block on the display 300 as needed. For instance, if two connection status values 0 (incomplete) and 1 (completed) are used, the indicating unit can associate color each of these values with a color. Red may be associated with 0, and green may be associated with 1. The indicating unit may then co-operate with the input/output module such that the changed color will be displayed on the display/screen 300.

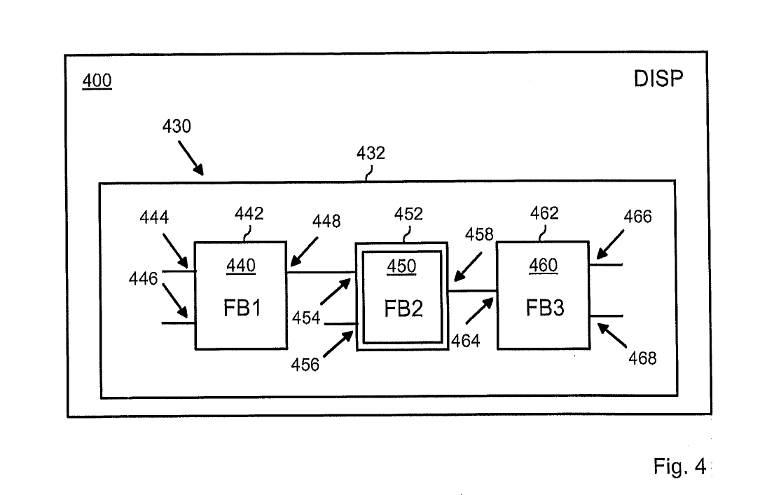

FIG. 4 shows an exemplary embodiment of a visual representation of an intelligent electronic device. The visual representation may be provided on a display 400. On the display, an intelligent electronic device 430 is shown. For the sake of clarity, only some of the function blocks and the configuration of an intelligent electronic device are shown in FIG. 4.

In the exemplary embodiment of FIG. 4, a visual indication of the completion status of the connections is provided using single or double frames around an object. The single frame denotes that the connections of the object are incomplete, whereas a double frame denotes that the connections are complete.

The device 430 includes three function blocks FB1 440, FB2 450 and FB3 460. In the example of FIG. 4, we may consider that the function block FB1 includes two obligatory inputs 444 and 446, and one obligatory output 448.

Of these inputs and output, only the output 448 has been connected and, therefore, the completion status of the connections of FBI is “incomplete”. This is visually indicated in FIG. 4 by having a single frame 442 around the function block FBI.

The function block 450 can, for example, have one obligatory input 454, one optional input 456, and one obligatory output 458. The obligatory input is connected to FBI and the obligatory output 458 is connected to FB3 and, therefore, the connection status of the block FB2 is “complete”, because when checking the connection status, the optional inputs/outputs are not taken into account when evaluating the connection status of the block. The “complete” connection status of the block FB2 is indicated visually by providing a double frame around the block FB2 on the display 400. The function block FB3 has one obligatory input 464 and two obligatory outputs 466 and 468. Only the obligatory input 464 has been connected and the connection status of the function block FB3 is “incomplete”, which is indicated in FIG. 4 with a single frame around the block 460.

Thus, in FIG. 4, one of the function blocks, FB2, has a “completed” status, whereas the two other blocks have an “incomplete” status. The total configuration of the device 430 is therefore “incomplete”, which is indicated by a single frame 432 around the device 430.

Any or all of the devices and/or function blocks disclosed herein can be implemented by software or hardware components. A combination of software and hardware implementation can also be used.

For example, a computer product, such as a computer disk, any volatile or nonvolatile computer memory, or any known digital storage device can be a computer readable medium encoded with a computer program of instructions which, when executed by a computer causes the computer to perform functions as disclosed herein. The functions reconfigure the computer to: provide a visual representation of a configuration of an intelligent electronic device with plural function blocks, wherein each function block is configured for executing a function in the intelligent electronic device and has a predetermined set of connection interfaces for connecting the function block with at least one of another function lock and an external variable; check a completion status of the connections of a function block provided in the configuration; and indicate, by using a visual indication in the visual representation, the completion status of the connections of the function block.

Those skilled in the art will appreciate that as technology advances, the inventive concepts disclosed herein can be implemented in various ways. The disclosure and its embodiments are not limited to the examples described above but may vary within the scope of the claims.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. An apparatus, comprising:
a configuration unit configured to provide a visual representation of a configuration of an intelligent electronic device with plural function blocks, wherein each function block is configured for executing a function in the intelligent electronic device and has a predetermined set of connection interfaces for connecting the function block with at least one of another function block and an external variable;
a checking unit configured to check a completion status of connections of at least one function block in the configuration; and
an indicating unit configured to provide the visual representation with a visual indication to indicate the completion status of the connections of the at least one function block.

2. The apparatus of claim 1, wherein the visual indication includes a first visual indication that the connections of the at least one function block have been completed.

3. The apparatus of claim 1, wherein the visual indication includes a first visual indication that the connections of the at least one function block have been completed, and a second visual indication that the connections of the at least one function block are incomplete.

4. The apparatus of claim 2, wherein the first visual indication includes a color.

5. The apparatus of claim 3, wherein the first visual indication includes a first color, and the second visual indication includes a color different than the first color.

6. The apparatus of claim 3, wherein the first visual indication is a first line thickness of a function block in the visual representation, and the second visual indication is a second line thickness of a function block other than the first line thickness.

7. The apparatus of claim 3, wherein the first visual indication is a single frame, and the second visual indication is a double frame of a function block in the visual representation.

8. The apparatus of claim 3, wherein the visual indication includes a third visual indication that the connections of the function block have been partly completed.

9. The apparatus of claim 1, comprising:
an indicating device configured to receive a user initiation for checking completion statuses of the connections in the configuration, wherein the checking unit is configured to operate upon the initiation received by the indicating device.

10. apparatus of claim 1, wherein the checking unit is configured to check the completion status of a function block when a change is made to a connection of a function block by comparing connections of the function block with obligatory connections defined for the function block, and to update the visual indication of the function block when the completion status of the function block is changed.

11. The apparatus of claim 1, wherein the intelligent electronic device is a protective relay.

12. A method, comprising:
visually representing a configuration of an intelligent electronic device with a plural function blocks, wherein each function block is configured for executing a function in the intelligent electronic device and has a predetermined set of connection interfaces for connecting the function block with at least one of another function block and an external variable;
checking a completion status of the connections of at least one function block in the configuration; and
visually indicating, in the visual representation, the completion status of the connections of the at least one function block.

13. The method according to claim 12, wherein the visual indication includes a first visual indication that the connections of the at least one function block have been completed.

14. The method according to claim 12, wherein the visual indication includes a first visual indication that the connections of the at least one function block have been completed, and a second visual indication that the connections of the at least one function block are incomplete.

15. The method according to claim 13, wherein the first visual indication includes a color.

16. The method according to claim 14, wherein the first visual indication includes a first color, and the second visual indication includes a color different than the first color.

17. The method according to claim 14, wherein the first visual indication is a first line thickness of a function block in the visual representation, and the second and visual indication is a second line thickness of a function block other than the first line thickness.

18. The method according to claim 14, wherein the first visual indication is a single frame of a function block, and the second visual indication is a double frame of a function block in the visual representation.

19. The method according to claim 14, wherein the visual indication includes a third visual indication that the connections of the at least one function block have been partly completed.

20. The method according to claim 12, comprising:
checking the configuration upon a user input indicating that a check should be performed on the completion status of the connections of the configuration.

21. The method according to claim 12, comprising:
checking the completion status of a function block when a change is made to a connection of a function block, wherein the checking of the completion status is carried out by comparing connections of the function block with the obligatory connections defined for the function block; and
updating the visual indication of the function block if the change changes the completion status of the function block.

22. The method according to claim 12, wherein the intelligent electronic device is a protective relay.

23. A computer program product stored on a computer readable medium encoded with a computer program of instructions which, when executed by a computer causes the computer to perform the following:
providing a visual representation of a configuration of an intelligent electronic device with plural function blocks, wherein each function block is configured for executing a function in the intelligent electronic device and has a predetermined set of connection interfaces for connecting the function block with at least one of another function block and an external variable;
checking a completion status of the connections of a function block provided in the configuration; and
indicating, by using a visual indication in the visual representation, the completion status of the connections of the function block.
